(19) United States
(12) Patent Application Publication
(10) Pub. No.: US 2013/0326589 A1
(43) Pub. Date: Dec. 5, 2013

(54) Event Centric Network Application

(71) Applicant: Gary D. Butler, Starkville, MS (US)

(72) Inventor: Gary D. Butler, Starkville, MS (US)

(21) Appl. No.: 13/484,141

(22) Filed: May 30, 2012

(51) Int. Cl. G06F 15/16; G06F 21/00

(52) U.S. Cl. 726/4; 709/203

(57) ABSTRACT

A system and method implementing an event centric network application including software controlled processes on one or more servers, and client applications or user side software processes controlling user hardware to implement social networking capabilities specifically aimed at and around multiuser attended events. A portal or server side software process serves event related communications between, the system hardware that is controlled by event organizers, advertisers, and individuals attending the event from user devices such as phones or other communications enabled computing devices. The system implements a single virtual environment or event centric electronic portal hosted on a system server and communicated to a user device through a communications interface on a user device.

### BACKGROUND OF THE INVENTION

1. Field of the Invention

The present invention relates to a system comprised of hardware controlled by software processes to create a portal or virtual space for delivery of timely event related content and the interchange of information and content related to a live social event.

2. Discussion of the Prior Art

Prior art social networking applications are generally passive. Prior art social networking applications rely on users to create content of interest to other users. Further, prior art social networking sites rely on HTTP pages or implementations and require users to constantly navigate between different pages or refresh pages to check if there is new content. As a result, prior art social networking applications not poorly suited for delivering timely relevant multimedia content as partially guided or controlled by a sponsor of a live event during the live event.

Social networking applications such as MySpace®, Facebook®, and Linkedln® are examples of prior art applications that serve content created by and communicated by the sites users. The respective applications provide dedicated storage for accounts and personal information that must be created by the user to be of interest to other users. Moreover, unless the sites' users frequently update or provide fresh content, the served content becomes stale and uninteresting. Further, other users must navigate the social networking application pages to access the spaces or pages of other users to determine if there is any content of common interest. This can make the social networking applications cumbersome and ill-suited for short lived or timed limited events, such as concerts, sporting events, and museum showings, where content is plentiful and rich in multimedia content and common interests are known beforehand.

Based on the above limitations of the prior art, it would be desirable to have a social networking application that enables event sponsors to host and serve content from the event to users attending the event, and to host and serve ad hoc or social networks of users attending the event and commenting on the event.

### BRIEF DESCRIPTION OF THE DRAWINGS

FIG. 1 illustrates a high-level block diagram of an embodiment of the hardware and software system of the invention;

FIG. 2 illustrates a flow diagram of processes enabled by the system 10 of the invention;

FIG. 3 illustrates an embodiment of the system user interface 7 accessed by a user device 2 in functional communication with the system and permitting user registration process, user login process, registered event search processes, and a visual representation of registered events accessible by registered users showing the ability to check-in to registered events;

FIG. 4 illustrates a user device 2 operating a client application or web browser in functional communication with the system 10 and embodying aspects of the invention; served event related content created prior 126 to the registered event, served event related content created or captured during 124 the registered event, and an ad hoc social network(s) served event related content created by users and served on the system 10 to user devices 2; and

FIG. 5 illustrates an embodiment showing ad hoc user networks 71 attending a registered event.

### SUMMARY OF THE INVENTION

The invention comprises an event centric social networking system and includes software controlled processes on one or more servers, and client applications or user side software processes controlling user hardware to implement social networking capabilities specifically aimed at and around multiuser attended events. A portal or server side software process serves event related communications between, the system hardware that is controlled by event organizers, advertisers, and individuals attending the event from user devices such as phones or other communications enabled computing devices. The system implements a single virtual environment or event centric electronic portal hosted on a system server and communicated to a user device through a communications interface on a user device.

Event organizers can promote their events to a global audience through registration of events in the system. The system comprises an organizer or event registrant interface through which events may be registered and defined and promoted to registered users of the system. The event registrant interface enables the definition of registered events to permit registered users to search for and find events of interest. The system also comprises a user interface that permits users to create user accounts and define their user profile based on entered preferences and interests and other known registered users, or with shared interests or similar profiles. The combination of defined registered events and users profiles permits the system to determine user-event compatibility scores to suggest events to users based upon a users profile as stored by the system.

Once an event is registered in the system, users who are registered in the system, have the ability to “check-in” to the registered event and begin receiving event related content from the system. Further, a notification of physical attendance from a user device such as by automated software processes or a user initiated communication (i.e. a “check-in”) enables users to receive event related content to their user devices as influenced by organizers. The system can also notify other users of a user's checked-in status. The check-in notification feature of the system enables the creation of ad-hoc networks of users within a common social framework and enables real-time interaction around the event through the use of instant messaging. Thus ad-hoc social networks of interested and registered users are formed at or around live registered events. The system 10 has commercial applications as the software and user accounts facilitate marketing and advertising firms to work through the system to purchase and submit advertisement that will be disseminated to and displayed on user devices 2.

The system simultaneously hosts or serves a plurality of registered events and supports large numbers of real-time user interactions around registered events. It benefits event organizers by supplying an additional conduit by which they can promote their event. It benefits fans by providing live feeds of multimedia content from both event promoters and fans present at the event site as determined by the GPS information acquired from their mobile device regarding the event that is not otherwise acquired before, during or after the event. It benefits advertisers by providing a framework for direct marketing to fans of events outside of the normal and more expensive media channels.

Several objectives are fulfilled by the invention. For example, it is an object of the invention to enhance an attendee's experience of live events through live feeds, images, and messaging with other friends or users on ad hoc user networks served by the system. It is also an object of the invention to permit event organizers to register, describe, and promote live events through the system, register individuals or users to attend the registered events, and provide advertisements to the users via their user devices all through a single web portal as opposed to searching for event related information through disparate set of event specific sites. And, it is an object of this invention to create and provide server messaging of ad hoc social networks comprised of users attending a registered event. The invention is described by the description and claims that follow.

### DESCRIPTION OF THE EMBODIMENTS

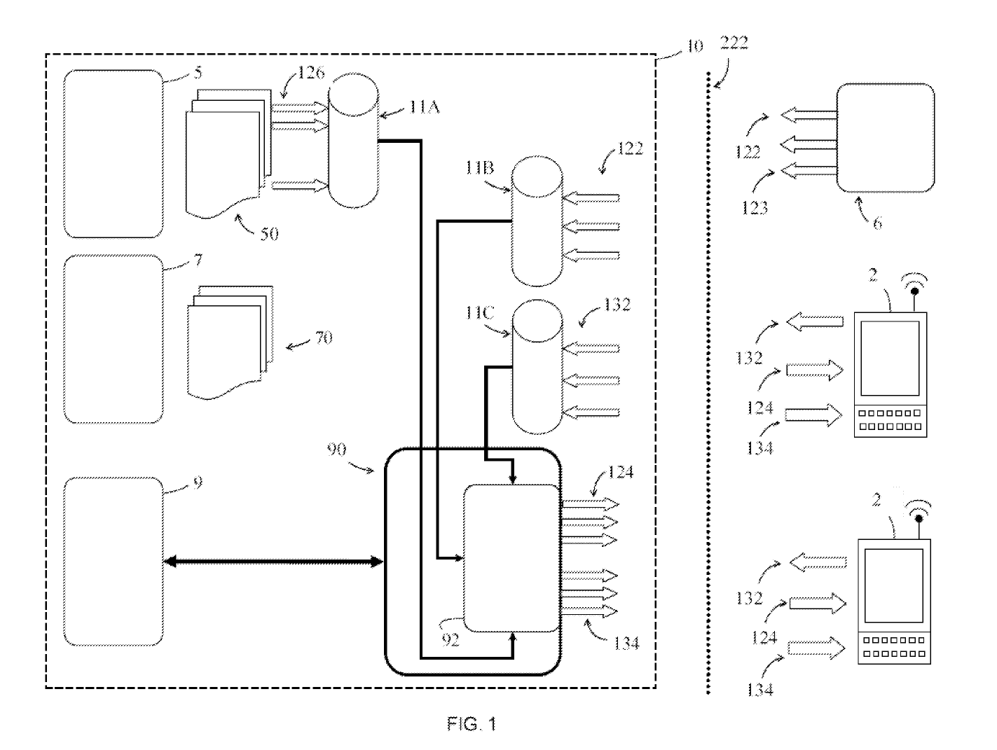

FIG. 1 shows a high-level block diagram of one embodiment of a system 10 according to one embodiment of the invention. The components shown are sufficient to disclose an illustrative embodiment for practicing the invention but are not meant to be exhaustive or limiting since the system 10 could be implemented in various hardware and software combinations. The system 10 is preferably realized on one or more software or hardware-based servers, or combinations of both, in functional communication with computer memory 11A-11C, which memory can be implemented in computer-readable media, namely computer storage media that can be volatile, nonvolatile, removable, and non-removable media implemented in any method or technology for storage of computer readable instructions, data structures, program modules, or other data.

The invention generally comprises a system 10 of hardware controlled by software processes by which an administrator, sponsor, or registrant causes event-related content or information to be served to one or more user devices 2 controlled by users that are attending an event and that is registered in the system 10 and for which event related content is deliverable to users. The system 10 comprises interfaces accessible over one or more networks 222 and includes a registrant interface 5, a user interface 7, and event-related production control interface 90 together with associated hardware. The registrant interface 10 permits a registrant to create a defined event 50 (a “registered event”) that contains event related content served by the system 10 to “fans” or users registered for and attending a registered event and having a user device 2. The user interface 7 permits users to register with the system 10, create a system identification and profile 70, “check-in” to registered events, and engage in social networking with other users that have registered with the system 10. The event-related production controls 90 enable the registrant to “produce” or control the delivery and management of event related content to users devices 2 present at a registered event.

User devices 2 are in functional communication with a system user interfaces 7 over a network 222 to implement the purposes and objects of the invention. The network 222 may be a local area network (LAN), a wireless network, a cellular network, and the like. User client devices 2 may include phones, computers or computing devices capable of communicating over a network 222 to send and receive data communications comprised of information, including social networking information, or the like. User client devices 2 connect to the system server 10 using one or more wired or wireless communications networks 222. Exemplary networks 222 include cellular communications networks, dedicated point-to-point networks, and local area networks. User devices 2 preferably include one or more network interfaces, an audio transducer, a display, a keypad for inputting and displaying information. User devices 2 further include positioning technology such as a global positioning system (GPS), WiFi triangulation, Cell Identity, or any technology or protocol that permits determination of the relative location of a user device 2 to physical coordinates or other devices. Network interfaces include circuits and components for coupling user devices 2 to at least one network 222, and is constructed and enabled for use with wired and wireless communication protocols and technologies including, but not limited to those protocols and technologies used in cellular and in distributed networks.

Registrant Interface

The system has an event registrant communications interface 5 service or server providing data communications access to the system 10, the function of which is to register and input event related content and information into the system 10. The interface 5 can be any combination of hardware or software that permits communication and access and an exchange of communications with the system 10 to achieve the purposes of the invention. The interface 5 is preferably accessed over a network such as by using a web browser, or alternatively comprised of a client application resident on a registrant's remote computing platform, which communicates with a system 10 application interface resident on the system server 10. As represented in FIG. 1, unique registrant accounts permit ready identification of each registrant and associated profile, contact, and billing information. The creation of a registered event 50 comprises creating an event instance and providing general and specific information and content regarding the event and may comprise populating an input form and providing details regarding the event. To accommodate the creation of registered events, the system 10 includes database records, memory locations, or other data structures 50 in computer memory representative of, or associated with, each registered event.

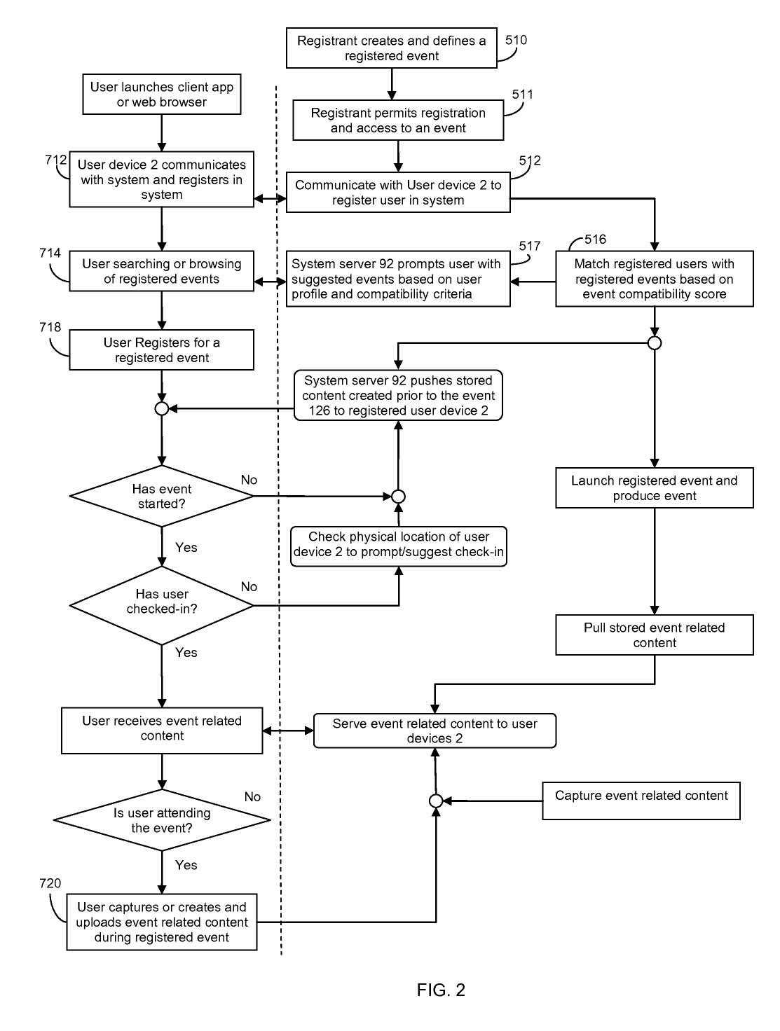

The registrant interface 5 preferably includes navigable software processes that facilitate the processes described in the flow diagram of FIG. 2. Each registered event is defined 510 by an event registrant. A registered event is characterized as a physical gathering of users having user devices 2 attending an occurrence of common user interest for which the system 10 has registered event and a registrant who defines characteristics of the event, and permits access to, and causes the system 10 to serve event related content to user devices 2 during the event. The event-related content preferably includes messaging communications served to ad hoc social networks comprised of user devices 2 and other event related content created by the registrant or a third party either prior to or during the event. Registrant interface 5 processes facilitate registrant creation and definition 510 of registered events, and granting access 511 to users to search, review, and ultimately, register for a registered event 512. Defining a registered event may include who, when, what, type event indicators but also additional details such as the type and quantity and quality of event related content that will be served by the system 10 to user devices 2. As one example a registrant such as a promoter of a concert can register a concert event on the system, permit users with user devices 2 to register with the system 10, check-in and attend the concert, serve one or more ad hoc social networks and cause other concert-related content to be served to user devices 2 contemporaneously with the concert.

The registrant may grant both premium and common access to the event. Users registering for premium access will be given access to additional or premium event related content or other perks and information that provides an enhanced user experience. Further, the system 10 also determines each user event compatibility score for each registered event and prompts or suggests 516 registered events that might be of interest to each user. The prompts or suggestions are communicated to each registered user device 2, and responses are communicated back to the system via the network 222. The determination of each user event compatibility score depends on one or more of the factors selected from the group consisting of interests, age, location of the user relative to the event, and historical event attendance. The registrant may define varied levels of access to a registered event using the registrant interface 50 and based upon criteria specified by the registrant. For example, the registrant may permit premium or unrestricted access rights to event related content based upon the users account qualifications or the payment of fees. Thus, a registrant can vary each user's event experience and exchange compensation or other legal consideration therefore. The creation of a registered event also initiates the compilation of information regarding users registered in the system 10. Once an event is registered, users will browse the registered events and ultimately select one or more registered events. The registrant therefore may perform market research on system users and in turn sell advertising opportunities to third parties based upon the number and nature of the profiles of users registered for an event. As an example, advertisement placement and pricing can be determined or influenced based on the number and demographic profile of users registered for and checked-in to a specific event. A registrant can charge more for placement of advertisement if there are a large number of checked-in or registered users. Alternatively and additionally, the registrant interface can permit whole or fractional sponsorship of registered events by third parties.

Before an event begins, and either before or after a user registers for the event, the registrant can push or communicate 518 previously-created and stored event-related content 126 to user devices 2 to further promote or provide information regarding the event. Content for the purposes of this description includes, but is not limited to, content storable in digital form in memory such as images, text, video, and music and preferably comprises commercial and noncommercial content related to the subject of the event. Exemplary stored content created prior to the event 126 includes but is not limited to advertisement, information regarding talent featured at the event, and other general type of information related to the event such as concessions, parking, or traffic. Further, the content preferably includes information such as ticket prices and the like, which helps users to make better-informed decisions regarding whether to attend and event. Finally, the system provides for the purchase of tickets for the registered event and may further provide incentives or discounts of purchasing admission or other event-related merchandise using the system 10. The communication of promotional information preferably culminates with the user registering 718 to attend the registered event.

After user registration and commencement of the registered event, the registrant produces 520 the registered event to enhance the attending user experience as is more fully described below. Further, upon attendance of the registered event, the user may provide electronic communication or notification of arrival and attendance 720 at the live event (i.e. checked-in status) to the event. Alternately, the system 10 monitors 519 the physical location of the user device 2 using GPS technology or another positioning technology capable of determining the approximate physical location of the user device 2 relative to physical coordinates. A checked-in status initiates one or more software processes by which the registrant can operate the system 10 and serve 517 contemporaneously captured or created event-related content to user devices 2, and serve ad hoc social networks comprised of users attending the registered event and messaging with each other using user devices 2.

User Interface

The system includes a user system interface 7 that allows users to register in the system 10, search for and select registered events and receive event related content during events. See FIG. 1. The user interface 7 exists on one or more servers 10 that are connected and communicate over the network 222 with user devices 2. The user interface 7 can be any combination of hardware or software that permits registrant access to the system to create a user account in the system. The system user interface 7 is preferably web based but could also be implemented in an application resident on the user device 2 that communicates with application interface on the system 10. Moreover, the system 10 hardware and software and user interface 7 provides access user account storage 70 in computer memory. The network 222 may be, for example, a local area network (LAN), a wireless network, a cellular network, or the like. The user interface 7 and user accounts 70 permits the user to enter and store user identification information and complete a personal profile that will allow the system administrator or registrant to suggest events that will interest the user. Each user profile includes multiple indicators of user interests and an exemplary user profile would include indications for preferred venues, locations, music styles, art, artists, sports, teams, books, authors, celebrities, or movies. The compilation of user information in user accounts 70 facilitates promotional activities by the registrant or system administrator since purchasers of advertising for events will know more accurately the demographic profile of attendees.

With reference to FIG. 2; after a user is registered 712 with the system 10, users can search 714 registered events for events of interest, or the system 10 can also match events to user profiles and suggest 517 events consistent with a user-event-compatibility score 516. The user-event-compatibility score is based on the event definition and the user profile or interests and as reflected in the user profile. Moreover, based on a user's registration for an event, the system 10 can weigh factors affecting the user-event-compatibility score such as whether other users registered for the event are users known or “friends”, or have similar interests, or demographic profiles. For example, user profile factors and statistical classification methods are used to match newly scheduled events with users. Upon selection or user registration 718 for an event, the system 10 can begin to serve 518 stored event-related content 126 to the user device 2 and serve messaging communications between user devices 2 possessed by users registered for the same event or events.

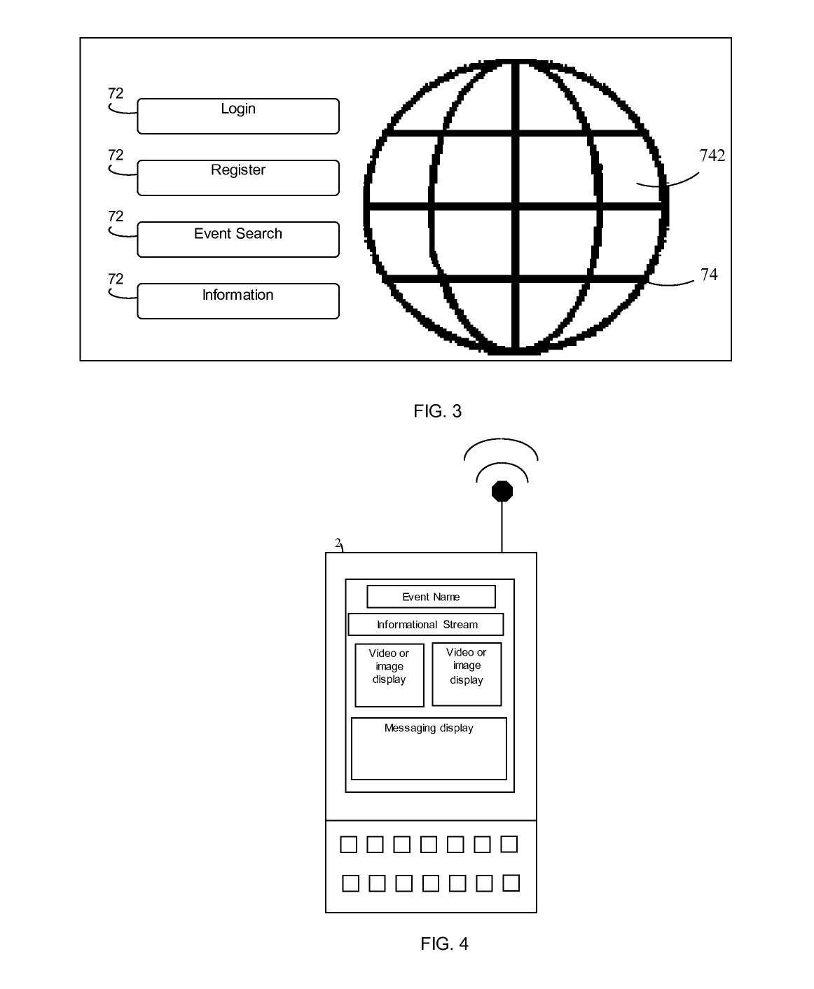

While user interfaces can be implemented in alternate manners, one preferred implementation of the user interface 7 communicates with a web browser or application resident or present on a user device 2 and comprises a combination of user-operated and system-operated processes or controls to facilitate user device 2 communications with the system 10. As illustrated in FIG. 3, a preferred user device 2 client application or browser displays includes software controls 72 associated with buttons and menus representative or representing navigable states representative and associated with user-controlled software processes such as user registration, user login, user event search, and news gathering functions. The user interface 7 also preferably includes a visual and user-controlled representation 74 of events including a plurality of active areas 742 associated with the visual and user controlled representation 74 and wherein each of the active areas 742 is representative of a registered event and contains information related to the event.

A preferred inclusion of information in the active area 742 includes a description of the event, the number of users registered for the event, and the countdown for when the event is scheduled to start, and a control operable by the user to select and register for an event or to check in to the event. The events displayed on the visual representation 75 on a user device 2 are influenced based on preferences or factors managed within each user account 70 or the system 10 and the determined user-event-compatibility score. In operation, the user interface 7 communicates data to the user device 2 to cause the user device 2 to display a visual representation of one or more registered events with associated software controls that are associated with each of the registered events and each visual representation displayed within boundaries circumscribing and delineating the visual representation the registered event from at least one other different registered event. For example, the illustrated visual representation 75 may include a countdown timer with a textual or graphical representation (or both) of information indicating the description of the event, the time until an event begins, and the number of users registered for an event.

Event Registration and Check-In

Users can search the registered events in the system 10 for events of interest, or the system 10 can also match events to user profiles and suggest events consistent with the user interests reflected in the user profile 714 or a user-event compatibility score. After the user registers 718 for an event, the system communicates 518 electronic reminders and other information pertinent to the event or that might be of interest to the user. As an example, if a user selects a museum showing an event, the system could push examples of works that will be displayed and complementary information such as commentary, interpretative information, and/or historical information. After the event begins, the users registered for the event may attend the event and electronically “check-in” 720 to the registered event and begin receiving 722 contemporaneously-captured or created event-related content, 122, 123, and 132, from the user experience content server 92. Attending the event for the purposes of the invention means that the user controlling the user device is located at the event. Further, the system may determine whether a user device 2 is at a live event by monitoring the physical location of the user device using GPS technology or another positioning technology capable of determining the approximate physical location of the user device, or alternatively the user may indicate attendance at the event by initiating a software control communication to the user interface 7 indicating to the system 10 that the user has “checked-in.”

The user experience server 92 serves event related content to registered users 72 to enhance the user's enjoyment of the event experience. Event-related content served from the system 10 originates from various sources and includes content created prior to the event 126 and content created contemporaneously or during the event and comprising for example, registrant captured content 122, third-party or talent-created content 123, and content created by user's 132 and input to the system from user devices 2 registered for and attending the registered event. See FIG. 1. The respective content 122, 123, and 132, is transmitted to system storage 11A-11C that is accessible and controlled by the software processes 90 of the user experience content server.

Event related content 124, 132, is served from the server 92 via network 222 to user devices 2, before and during the registered event. The user experience server 92 comprises a processing engine controlled by software processes 90 and in functional communication with mass storage elements, 11A-11C, storing event related content. The user experience server 92 further comprises communications hardware and software processes to transmit and receive event related content to user devices 2 during a registered event and according to managed preferences of either the registrant or each user. The user experience server 92 also includes hardware controlled by software processes to manage one or more ad hoc 719 networks created and operated during registered events and manage software process to receive event related content captured on user devices 2 by users attending the event and conditioned or based on the user device 2 GPS localization information 720. At the time of event registration, the registrant inputs the physical address of the event and related conditions such as GPS coordinates corresponding to boundary coordinates used by the software process and the server 92 to determine whether a user and user device 2 are within the boundary coordinates and can be considered to be “attending” or alternately, outside the boundary coordinates and therefore considered to be“not attending” the event. If the user and user device 2 are considered to be “attending” then the server 92 will support the serving including the collection and transmission of content from event attendees. This event related content will include information in the form of text, pictures, video and audio format.

Exemplary stored content created prior to the event 126 includes, but is not limited to, advertisements or other commercial content, information regarding the event such as the talent, works, or teams featured at the event, and other general types of information related to the event such as concessions, parking, or traffic. Registrant or talent captured or created content 122 comprises contemporaneous created or captured content intended for consumption by users 72 at a registered event. Captured content 122 and 123 may come from cameras, microphones, or the subject of the event e.g. the talent. The content 122 and 123 is thereafter communicated over the network 222 to storage 11B or 11C accessible by the user experience content server 92. User created content 132 is provided by user devices 2.

The messaging service 724 served on the system 10 is preferably provided by a resident client application or event web interface on a user device 2 and in communication with the user interface 7 and enabled for participating in and managing a messaging session using any of a variety of messaging services or protocols including, but not limited to, email, Short Message Service (SMS), Instant Message (IM), Multimedia Message Service (MMS), internet relay chat (IRC), mIRC, or the like. The messaging service enables the system 10 to locate the user device 2 based on the user's registration for an event, a social network, a GPS coordinate associated with user device 2, and/or other search criteria.

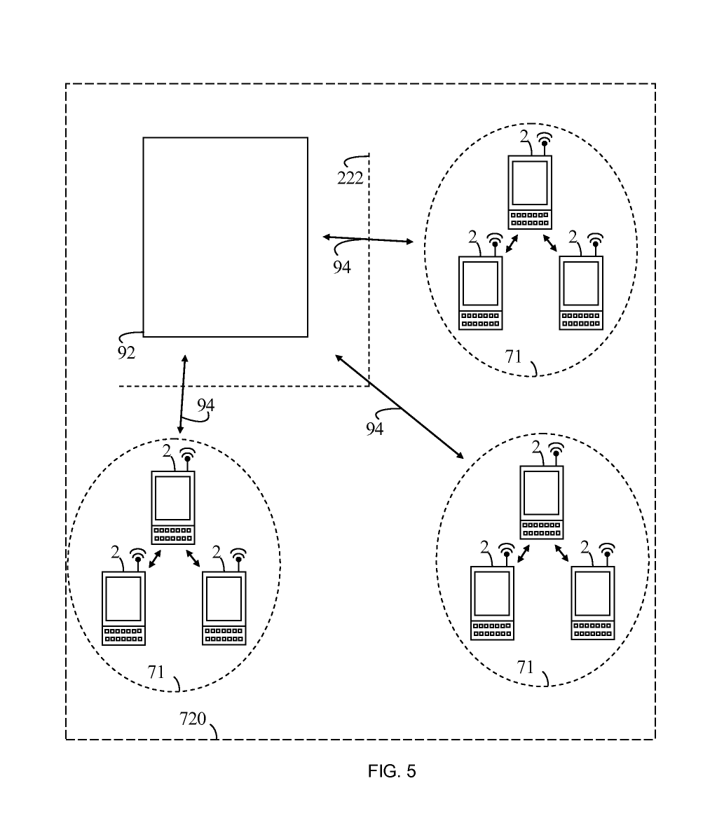

FIG. 5 illustrates ad hoc user networks 718 served over the network 222. Messaging communications from user devices 2 are served 94 via the user interface 7 and transmitted over the network 222 to a plurality of user networks 71 comprised of at least two user devices 2 but fewer than all of the user devices 2 attending the event. Further, the system 10 can serve messaging communications between user devices 2 from within a predetermined boundary 720 of physical coordinates circumscribing the physical location of the event. The system 10 can determine the location of each user device 2 data communicated from the user device 2 to the user interface 7 and originating from a GPS receiver or transceiver functionally coupled to the user device 2.

After user registration and commencement of the registered event, the registrant produces 520 the registered event to enhance the attending user experience. Production of the event comprises management of the software controlled processes of serving event related content to each registered user device 2 during the registered event. Production of an event also includes contemporaneous collection 522 of event related content and decisions regarding when and what content to push to users and when to communicate to user devices. Production may include monitoring of user chat, email, or text communications to determine pertinent information to be pushed to event-attending-users phones or computers and relay information to advertisers about the user experience.

In one embodiment of the system 10, after an event begins, and at least one user has registered for and checked in to a registered event via their user device 2, the registrant begins production 518 of the registered event using a user experience server 90. Upon launching of an event, the system 90 manages and serves messaging and content for ad hoc user networks on user devices 2. Management of the ad hoc user networks comprises serving messages between two or more of user devices 2 using IM, SMS, email, or VOIP messages controlled by users physically attending the registered event.

As illustrated in FIG. 1, the registrant is on-site for the registered event and controls user experience server 90 to select and serve stored event related content 126, optional talent-created event-related content 122, and user-created event-related content 132. Transmitting or server communications of registrant-selected and stored-event related content 126 and optional talent-created event-related content 122 is transmitted to all user devices 2 located at the event. Serving of user-created event-related content 132 such as messaging communications is to smaller ad hoc networks 718 comprised of fewer than all of the user devices 2 at the event.

After registering for an event, the user may attend the registered event and “check-in” via a transmission or communication from the user device 2 to the user interface 7, and begin receiving event-related content from the user experience server 92, or participate in one or more ad hoc networks hosted on the server 92. Participating in an ad hoc network 718 at a registered event comprises experiencing the live event, transcribing or entering comment, interpretation, or opinion regarding the event into a user device 2, and transmitting and receiving via the network 222 event-related content comprised at least partly of event related communications captured or created by another event attendee with a client device 2 that is checked-in to a registered event 70. The event-related content served from the system 10 may be any combination of images, video, or text related to the event

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A system configured to serve communications for a plurality of events, comprising:
a server coupled to computer memory and over a network with user devices, the computer memory storing event-related content selected from images, video, text, and messaging communications, of which a first portion of the event-related content is created or captured before the event and of which a second portion of the event-related content is created or captured during the event;
a registrant interface configured for control from a remote computing device to receive event-related content from inputs to the registrant interface and each of the user devices located within a geographic boundary associated with the geographic location for the event;
multi-access user interface accessible over the network having unique user accounts each user account configured to store user event indications including registration for an event, an authorization to receive event-related content for the same event, and a geographic location of the user device; and
wherein the server is configured to transmit event-related content to user devices associated with user accounts having the registration for the event and the authorization to receive the event-related content, and receive and transmit event-related content to user accounts with the geographic location of the user device within the geographic boundary and having the registration for the event and the authorization to receive the event-related content.

2. The system in claim 1 wherein,
the geographic boundary associated with the geographic location for the event corresponds to GPS coordinates circumscribing the geographic location of the event.

3. The system in claim 1 wherein,
the server is configured to serve to user devices a visual representation of the plurality of events and countdowns for the events, and the server is configured to access and determine the user event indications having registration for one of the events and authorization to receive event-related content and further serve to the user devices associated with same user accounts the event-related content.

4. The system in claim 3 wherein,
each user device is configured to display a visual representation of a registered event with an associated software control associated with the registered event and within boundaries circumscribing and delineating the visual representation of the registered event from at least one other of the plurality of events.

5. The system in claim 4 wherein,
the server is configured to transmit data to the user device to cause the user device to display event-related content created for and during the registered event.

6. The system in claim 5 wherein,
the data transmit is influenced by information stored in a user profile on the system.

7. A method of serving to user devices event-related communications for a plurality of events, comprising:
storing in computer memory event-related content for each of the plurality of events selected from images, video, text, and messaging communications, of which a first portion of the event-related content is created or captured before the event and of which a second portion of the event-related content is created or captured during the event, a geographic boundary associated with the geographic location for the event, and an associated start time for each event;
accessing each of a plurality of unique user accounts, each user account associated with a user device and configured to store user configured indications comprising a user's registration for an event and the user's authorization to receive event-related content for the same event;
determining the geographic location of the user device based on data generated by the user device and receiving the second portion of event-related content from user devices within the geographic boundary, and after the associated start time; and
serving event-related content to user devices associated with user accounts having the registration for the event and the authorization to receive the event-related content.

8. The method in claim 7 wherein,
determining the geographic location of the user device based on data generated by the user device comprises selecting from reading GPS coordinates from the user device.

9. The method in claim 7 further comprising,
serving a visual representation of the plurality of events to each user device associated with a user account.

10. A method of serving event-related content to user devices using a system application, comprising:
receiving input transmissions to a registrant interface service of the system application, wherein the inputs are stored in computer memory and describe a starting time of, a location for, a subject matter of, and event-related content created prior to and for, a live event;
receiving inputs from user devices to a user interface service in the system application, wherein the inputs from user devices are stored in computer memory in unique user accounts and define user profiles describing the interests of each individual controlling each of the user devices;
receiving an input from the user device to the user interface as a precondition to receive event-related content;
after the starting time of the live event, capturing event-related content created from the user devices located at and created during the live event, and
during the live event, serving both the event-related content created prior to and during the live event to the user devices.

11. The method of claim 10 further comprising,
capturing, and serving to the user devices, event-related content created during the live event from sources other than the user devices and selected from the group consisting of microphones, video cameras, and still image cameras.

12. The method of claim 10 further comprising,
monitoring the location of at least one of the user devices using positioning technology capable of determining the approximate physical location of the user device; and
transmitting through the user interface to the user device a communication that displays a software control prompting an individual controlling one of the user devices to register for the live event.

13. The method of claim 12 further comprising,
receiving an input to the user interface a communication indicating that the user device is located at the live event.

14. The method of claim 13 wherein,
the input includes data representing physical coordinates and generated from a positioning technology receiver functionally coupled to the user device.
